(19) United States
(12) Patent Application Publication
(10) Pub. No.: US 2014/0143006 A1
(43) Pub. Date: May 22, 2014

(54) Systems and Methods to Enhance Product Yield for Semiconductor Manufacturing

(71) Applicant: TAIWAN SEMICONDUCTOR MANUFACTURING CO. LTD., Hsinchu (TW)

(72) Inventor: Yung-Cheng Chang, ShinChu City (TW)

(73) Assignee: Taiwan Semiconductor Manufacturing Co. Ltd., Hsin-Chu (TW)

(21) Appl. No.: 13/678,600

(22) Filed: Nov. 16, 2012

(51) Int. Cl. G06Q 10/06

(52) U.S. Cl. CPC G06Q 10/06315
USPC 705/7.25

(57) ABSTRACT

A system for fabricating semiconductor products includes a list of products to be fabricated, a list of available semiconductor fabrication tools, a product and tool matrix database, and a product and tool selection engine. The product and tool matrix database is configured to include performance and manufacturing information for the products to be fabricated and the available tools. The product and tool selection engine is configured to generate an enhanced matching of the products to be fabricated and the available semiconductor fabrication tools.

### BACKGROUND

Semiconductor device fabrication is a process used to create integrated circuits that are present in everyday electrical and electronic devices. The fabrication process is a multiple-step sequence of photolithographic and chemical processing steps during which electronic circuits are gradually created on a wafer composed of a semiconducting material. Silicon is an example of a typical semiconductor material used in the fabrication process, however other types of semiconductor materials can be utilized.

The various processing steps fall into a number of categories including deposition, removal, patterning, and modification of electrical properties (i.e., doping). Each step of the fabrication process is performed with input parameters selected to yield desired device characteristics for that step. Problems can occur when variations in input parameters, variations in process tools, and the like result in characteristics that deviate from the desired characteristics. These deviations or defects can lead to lowered performance, premature failures, and/or failed devices.

### BRIEF DESCRIPTION OF THE DRAWINGS

FIG. 1 is a block diagram illustrating a system for fabricating semiconductor products that enhances value according to cost.

FIG. 2 is a block diagram illustrating a system for fabricating semiconductor products in greater detail.

FIG. 3 is a flow diagram illustrating a method of generating an enhanced matching for products to be fabricated with available semiconductor fabrication tools.

### DETAILED DESCRIPTION

The description herein is made with reference to the drawings, wherein like reference numerals are generally utilized to refer to like elements throughout, and wherein the various structures are not necessarily drawn to scale. In the following description, for purposes of explanation, numerous specific details are set forth in order to facilitate understanding. It may be evident, however, to one skilled in the art, that one or more aspects described herein may be practiced with a lesser degree of these specific details. In other instances, known structures and devices are shown in block diagram form to facilitate understanding.

Generally, semiconductor fabrication involves performing a relatively large number or process steps on a wafer or semiconductor material in order to produce a desired semiconductor integrated circuit. The fabrication process is a multiple-step sequence of photolithographic and chemical processing steps during which electronic circuits are gradually created on a wafer composed of a semiconducting material.

The process steps can be broken down into front end of line (FEOL) processing and back end of line (BEOL) processing. In one example, over 300 sequenced process steps are required to form an integrated circuit on a semiconductor wafer.

The process steps are performed by one or more semiconductor fabrication tools. The tools can be specific to particular fabrication steps, types of devices, wafer sizes, and other characteristics. The tools can vary in terms of tool manufacturer, quality, and the like.

One issue in the fabrication of semiconductor devices using semiconductor fabrication tools is resulting defect. A goal is to fabricate a product that has zero defects, which is referred to as a golden product. However, forming such a product can be difficult due to almost unavoidable defects in the semiconductor fabrication process.

Defects are typically measured in terms of defect density and lead to variations in product yield.

The product yield is the proportion of devices formed on a wafer that operate properly or within specifications. The product yield can vary substantially according to the product being fabricated and the fabrication tool being utilized to fabricate the product.

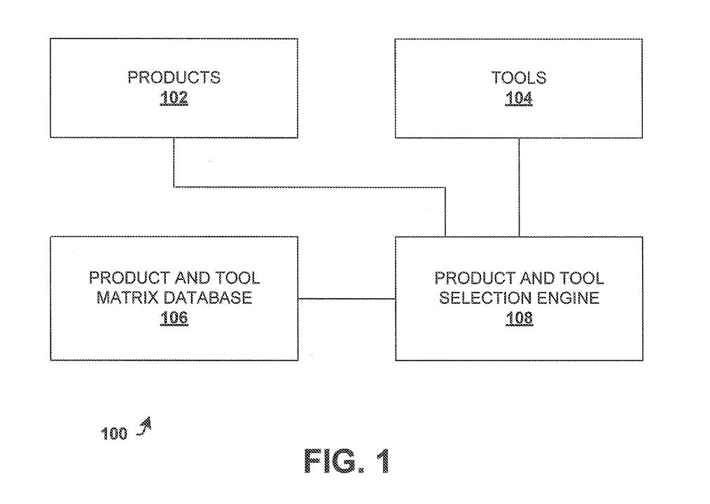

FIG. 1 is a block diagram illustrating a system 100 for fabricating semiconductor products that enhances value according to cost. The system 100 enhances value, including product yield, by selecting and/or assigning products to fabrication tools based on tool performance versus products.

The system 100 includes semiconductor products 102, semiconductor fabrication tools 104, a product and tool matrix database 106, and a product and tool selection engine 108. The semiconductor products 102 include one or more semiconductor devices to be fabricated. The products 102 include processors, memory devices, amplifier devices, and the like.

The semiconductor fabrication tools 104 include a plurality of tools configured to fabricate at least portions of the products 102. In one example, the tools 104 are able to fabricate all of the products 102. Generally, it is more cost effective for each tool to support fabrication for all of the products 102 in any application. If all of the tools 104 provided the same performance according to product, it wouldn't matter which tool was used to fabricate which products. However, different tools have different performance characteristics for different products. These varied performance characteristics are referred to as performance gaps. The matching of tool performance with products is referred to as tool matching.

Fabrication of certain, advanced products requires advanced manufacturing technology in tools. Advanced products include larger wafer sizes and smaller dies. The advanced tools have an even greater performance gap because they require more capable tools.

The performance gaps can be expressed in characteristics that relate the products 102 to the tools 104. In one example, the performance gaps include product yield. Thus, individual tools can have varied product yields for a given product. For example, a first tool can have a higher product yield for a first product A, but a lower yield for a second product B. Then, a second tool has a lower product yield for the first product A and a higher yield for the second product B.

The product tool and matrix database 106 includes a matrix that relates information including performance gaps per product for all of the semiconductor fabrication tools 104. The performance gaps are included for all of the products 102. The performance information relates the fabrication tools 104 with the products 102 and facilitates selection or assignment of the products 102 to the tools 104. The performance information includes tool performance and manufacturing need, for example, product yield, defect density, cycle time, OEE, queue time, and the like.

The product tool and selection engine 108 assigns the products 102 to the tools 104 according to the performance gap information from the matrix database 106. The engine 108 performs an analysis in order to determine which fabrication tool of the tools 104 is assigned to which product of the products 102. In one example, the engine 108 identifies assignments that provide an overall higher product yield for the products 102 collectively.

The engine 108 can also exclude a portion of the tools 104 from being utilized for one or more products. For such cases, the engine 108 determines that the portion of the tools 104 are not suitable or compatible with the one or more products. As a result, the one or more products are not assigned to the identified unsuitable tools. Thus, fabrication using unsuitable tools of the fabrication tools 104 is mitigated.

For a given product of the products 102, the engine 108 analyzes the product gap information from the matrix database 106 to find a suitable tool to assign for fabrication of the product. It is appreciated that at least some of the tools 104 have product yields that vary according to product. Thus, a given tool can have a higher product yield for one product than another. Thus, in one example, the engine 108 finds a tool having the highest product yield for the current product. In another example, the engine 108 selects a tool having a product yield above a threshold value.

As a result of the above, the product tool and selection engine 108 develops or matches the assignments of the products 102 to corresponding tools in order to provide an enhanced yield. The assignments that provide the enhanced yield are referred to as an enhanced matching. The enhanced matching facilitates product yield, mitigates defects, mitigates process shift or variations of products fabricated on varied tools, and reduces cost of fabrication. Process shifts can occur when a same or similar product is fabricated on by fabrication tools having different characteristics. The enhanced matrix can also be developed to mitigate the process shifts. The costs of fabrication can also be taken into account for developing the enhanced matching. The costs of fabrication can include tool resources, time, equipment costs, and the like.

The database 106 can be updated based on fabrication and testing results. As products/devices are fabricated by the tools 104, additional performance information can be developed/updated relating the products 102 to the tools 104. Thus, over time, the generated value can be increased by further improving generation of the enhanced matrix of assignments and the product matrix database 106.

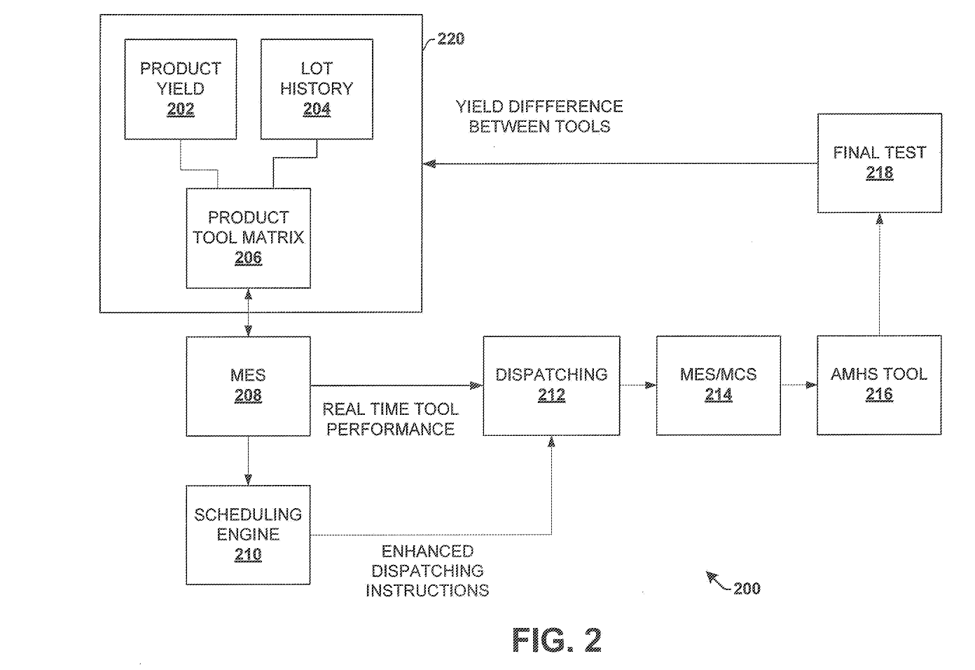

FIG. 2 is a block diagram illustrating a system 200 for fabricating semiconductor products in greater detail. The system 200 enhances generated value according to cost by selecting and/or assigning products to be fabricated to fabrication tools according to tool performance and manufacturing needs.

The system 200 includes a product and tool matrix database 220, a manufacturing execution system (MES) 208, a scheduling engine 210, a dispatching component 212, a manufacturing control system (MCS) 214, an automated material handling system (AMHS) tools 216, and a test component 218. The tool database 220 includes product yield information 202 and lot history information 204. The product yield information 202 includes information related to fabrication of a plurality of semiconductor devices or products on a plurality of semiconductor fabrication tools. The lot history information 204 includes information on various lots of products that have been fabricated by the tools of the system 200.

The product yield information 202 can include a proportion of successfully fabricated products for each of the tools. Although not shown, it is appreciated that other product gap or product information can also be present in the database 220. The lot history information 204 includes fabrication test results for various lost and the tools over time. The history information 204 can be aggregated to average values and to develop the product yield information 202.

The product tool database 220 also includes a product tool matrix 206, which relates products to be fabricated with the tools of the system 200. The product tool matrix 206 is developed from the product yield information 202 and the lot history 204. The product tool matrix 206 correlates information on the products to be fabricated with the available tools. The product tool matrix 206 can include other information related to the products and the tools of the system 200 including, but not limited to, cycle time, queue time, manufacturing costs per tool, and the like.

The manufacturing execution system 208 controls fabrication according to specification or quality measures for the products to be fabricated. The MES 208 can track quality, traceability, and productivity for the products to be fabricated. Further, the MES 208 receives the product tool matrix information from the product tool database 220 and can provide the database 220 with updated information related to the tools and products including, an updated list of available tools. The available tools can vary over time as fabrication tools become available, unavailable due to repair, and the like.

The MES 208 provides manufacturing information and performance information to the scheduling engine 210. The manufacturing information includes information for the available tools and can include, produce recipe, operating environment, tool performance benchmarks, and the like. The performance information includes the product tool matrix information and correlates with the products to be tested. The scheduling engine 210 uses the manufacturing information and the performance information to assign the products to be fabricated with the available tools. The engine selects assignments to enhance value according to costs. The enhanced value includes enhanced or improved product yield, mitigation of defects, fabrication time, and the like. The costs include tool operation costs, time duration, tool resources, time, equipment costs, and the like.

The dispatching component 212 receives the enhanced matching from the scheduling engine 210 and the real time tool performance information from the MES 208. The dispatching component 212 handles or implements the assigning of the products to be fabricated with the available tools. Each of the products to be fabricated is physically moved or transferred to an assigned tool of the available tools. The dispatching can be fully automated and/or involve some amount of manual interaction.

The machine control system (MCS) 214 controls operation of the available tools and can perform moving of the products to the available tools. The AMHS tools 216 perform fabrication of the products and are under the control of the MCS 214. During and after fabrication, information related to the product fabrication can be obtained and provided to the database 220 or the final test component 218.

The final test component 218 collects sensor information and fabrication related information from at least the tools 216. The sensor information and other information include the proportion of successfully fabricated products or devices, the product yield. The final test component 218 aggregates the test information and provides the test information to the product tool database 220, in order to enhance the database 220. The product and tool database 220 updates the product yield 202, the lot history 204, and the product tool matrix 206 based on the test information.

Thus, the system 200 generates enhanced matching and can perform fabrication of the products using the available semiconductor fabrication tools. The enhanced matching facilitates product yield, mitigates defects, mitigates process shift or variations of products fabricated on varied tools, and reduces cost of fabrication. The enhanced matching can be utilized in 450 mm and advanced process manufacturing.

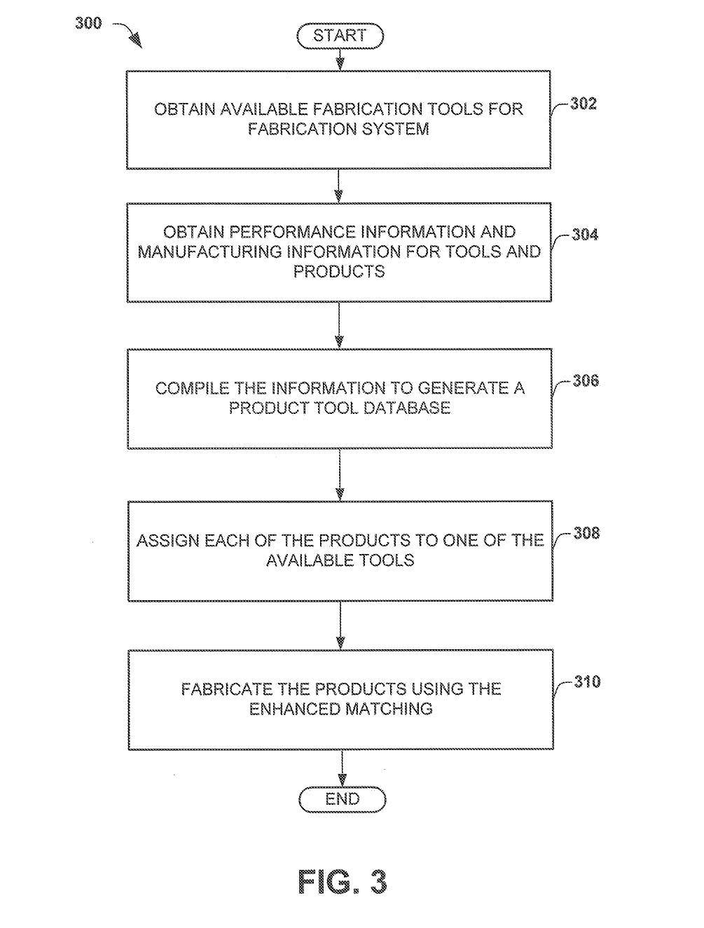

FIG. 3 is a flow diagram illustrating a method 300 of generating an enhanced matching for products to be fabricated with available semiconductor fabrication tools. The method 300 utilizes prior test data and the like to generate enhanced assignments of products to fabrication tools according to increase or enhance value and mitigate cost.

The method begins at block 302, wherein available semiconductor fabrication tools for a system are obtained. The available tools can be obtained from a manufacturing system, such as a manufacturing execution system (MES).

Performance and manufacturing information for the available tools is obtained at block 304. The information is obtained according to a list of products to be fabricated. In one example, the information includes product yield for each tool per product.

The performance and manufacturing information is compiled for the available tools and the product to be fabricated to generate a product tool database at block 306. Suitable techniques for compiling, or generating the product tool database are described above with regards to FIGS. 1 and 2.

The products are assigned to the available tools according to the product tool database at block 308. The assignments are provided in the form of an enhanced matching of the products to the tools. The enhanced matching facilitates product yield and mitigation of defects by considering the performance information and the manufacturing information for the tools and products. The products are assigned to increase or enhance value and reduce costs.

The enhanced matching assignments are utilized to fabricate the products on the assigned tools at block 310. The products are fabricated with enhanced value, such as enhanced product yield.

It will be appreciated that while reference is made throughout this document to exemplary structures in discussing aspects of methodologies described herein (e.g., the structure presented in FIGS. 1-2, while discussing the methodology set forth in FIG. 3), that those methodologies are not to be limited by the corresponding structures presented. Rather, the methodologies (and structures) are to be considered independent of one another and able to stand alone and be practiced without regard to any of the particular aspects depicted in the Figs.

A system for fabricating semiconductor products includes a list of products to be fabricated, a list of available semiconductor fabrication tools, a product and tool matrix database, and a product and tool selection engine. The product and tool matrix database is configured to include performance and manufacturing information for the products to be fabricated and the available tools. The product and tool selection engine is configured to generate an enhanced matching of the products to be fabricated and the available semiconductor fabrication tools.

A system for fabricating semiconductor products is also disclosed. The system includes a product tool database, a plurality of available tools, a manufacturing control system and a scheduling system. The product tool database is configured to generate and update a product tool matrix of information. The manufacturing control system is configured to perform semiconductor fabrication for a plurality of products on the plurality of available tools according to dispatching instructions, such as enhanced matching information. The scheduling engine is configured to generate the dispatching instructions for the plurality of products according to the product tool matrix of the product tool database.

A method of generating and utilizing en enhanced matching for tools and products is disclosed. Available fabrication tools for semiconductor products to be fabricated is obtained. Performance and manufacturing information for the available tools according to the semiconductor products is obtained. The performance and manufacturing information for the available tools and the semiconductor products is compiled. An enhanced matching of the semiconductor products to the available fabrication tools is generated. The enhanced matching improvise value and lowers cost. The enhanced matching is generated using the product tool database.

Also, equivalent alterations and/or modifications may occur to those skilled in the art based upon a reading and/or understanding of the specification and annexed drawings. The disclosure herein includes all such modifications and alterations and is generally not intended to be limited thereby. For example, although the figures provided herein, are illustrated and described to have a particular doping type, it will be appreciated that alternative doping types may be utilized as will be appreciated by one of ordinary skill in the art.

In addition, while a particular feature or aspect may have been disclosed with respect to only one of several implementations, such feature or aspect may be combined with one or more other features and/or aspects of other implementations as may be desired. Furthermore, to the extent that the terms “includes”, “having”, “has”, “with”, and/or variants thereof are used herein, such terms are intended to be inclusive in meaning—like “comprising.” Also, “exemplary” is merely meant to mean an example, rather than the best. It is also to be appreciated that features, layers and/or elements depicted herein are illustrated with particular dimensions and/or orientations relative to one another for purposes of simplicity and ease of understanding, and that the actual dimensions and/or orientations may differ substantially from that illustrated herein.

What is claimed is:

1. A system for fabricating semiconductor products, the system comprising:
a list of products to be fabricated;
a list of available semiconductor fabrication tools;
a product and tool matrix database configured to include performance and manufacturing information for the products to be fabricated and the available semiconductor fabrication tools;
a product and tool selection engine configured to generate an enhanced matching of the products to be fabricated to the available semiconductor fabrication tools.

2. The system of claim 1, wherein the list of products includes processors and memory devices.

3. The system of claim 1, wherein the list of products includes products not previously fabricated by the available fabrication tools.

4. The system of claim 1, wherein the list of available semiconductor fabrication tools includes tools able to fabricate all of the products.

5. The system of claim 1, wherein the list of available semiconductor fabrication tools is updateable.

6. The system of claim 1, wherein the performance information includes product yield.

7. The system of claim 1, wherein the performance information includes previous lot testing information for each of the available tools.

8. The system of claim 1, wherein the manufacturing information includes cycle time.

9. The system of claim 1, wherein the enhanced matching dispatches each of the products to a different tool of the available tools.

10. The system of claim 1, wherein the enhanced matching provides an enhanced overall product yield.

11. The system of claim 1, wherein the enhanced matching prevents one or more of the products to be tested from being assigned to incompatible tools of the list of available tools.

12. The system of claim 1, wherein the enhanced matching mitigates process shift.

13. A system for fabricating semiconductor products, the system comprising:
a product tool database configured to generate and update a product tool matrix, a plurality of available tools;
a manufacturing control system configured to perform semiconductor fabrication for a plurality of products on the plurality of available tools according to dispatching instructions; and
a scheduling engine configured to generate the dispatching instructions for the plurality of products according to the product tool matrix from the product tool database.

14. The system of claim 13, further comprising a dispatching component configured to dispatch the plurality of products to the available tools according to the dispatching instructions.

15. The system of claim 14, further comprising a manufacturing execution system configured to receive the product tool matrix and provide real time tool performance of the available tools to the dispatching component and the scheduling engine.

16. The system of claim 13, further comprising a test component configured to gather performance information from the available tools and provide the performance information to the product tool database.

17. The system of claim 16, wherein the performance information includes product Meld for the plurality of available tools for the plurality of products.

18. A method of generating and utilizing an enhanced matching for tools and products, the method comprising:
obtaining available fabrication tools for semiconductor products to be fabricated;
obtaining performance and manufacturing information for the available tools according to the semiconductor products;
compiling the performance and manufacturing information for the available tools with the semiconductor products to generate a product tool database; and
generating an enhanced matching of the semiconductor products to the available fabrication tools to enhance value and lower cost using the product tool database,

19. The method of claim 18, further comprising using the enhanced matching to fabricate the products on the available tools.

20. The method of claim 18, wherein generating the enhanced matching includes assigning each of the semiconductor products to one of the available tools according to product yield.
